(19) United States
(12) Patent Application Publication
(10) Pub. No.: US 2015/0298365 A1
(43) Pub. Date: Oct. 22, 2015

(54) METHOD FOR PRODUCING MICROSTRUCTURE AND PHOTOCURABLE COMPOSITION FOR NANOIMPRINTING

(71) Applicant: Daicel Corporation, Osaka-shi, Osaka (JP)

(72) Inventors: Takao YUKAWA, Himeji-shi (JP); Hiroto MIYAKE, Himeji-shi (JP); Tomoya MIZUTA, Himeji-shi (JP)

(73) Assignee: DAICEL CORPORATION, Osaka-shi, Osaka (JP)

(21) Appl. No.: 14/647,204

(22) PCT Filed: Nov. 11, 2013
(86) PCT No.: PCT/JP2013/080421

§ 371 Date: May 26, 2015

(30) Foreign Application Priority Data
Nov. 27, 2012 (JP) 2012-258996

(51) Int. Cl. B29C 33/58; C08G 59/02; B29C 59/02

(52) U.S. Cl. CPC B29C 33/58; B29C 59/022; C08G 59/022

(57) ABSTRACT

Provided is a method for producing a microstructure that enables continuous transfer with good mold releasability even without subjecting the mold to a surface release treatment.

The method for producing a microstructure according to the present invention includes preparing a mold having a relief-patterned surface. A substrate is separately prepared. A liquid photocurable transferable material layer is formed and sandwiched between the substrate and the mold to be shaped. The shaped transferable material layer is exposed to be converted into a photocured layer. The photocured layer is demolded from the mold to give the microstructure. The mold is prepared from a siloxane-bond-containing polymeric organic compound. The transferable material layer is formed from a photocurable composition including a cationically polymerizable compound (A) and a photoacid generator (B). The cationically polymerizable compound (A) in the photocurable composition includes at least one compound selected from the group consisting of compounds represented by Formula (I) and compounds represented by Formula (II):

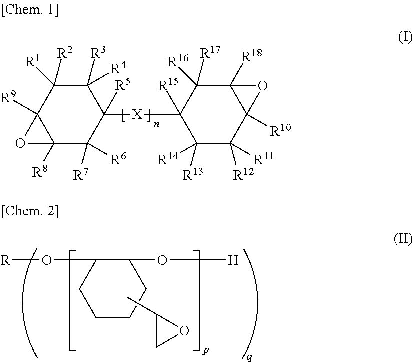

### TECHNICAL FIELD

The present invention relates to methods for producing microstructures; and photocurable compositions for nanoimprinting. More specifically, the present invention relates to a method for producing a microstructure by nanoimprinting transfer using a mold; and a photocurable composition for nanoimprinting for use in the production method. The present application claims priority to Japanese Patent Application No. 2012-258996 filed to Japan on Nov. 27, 2012, the entire contents of which are incorporated herein by reference.

### BACKGROUND ART

Nanoimprinting techniques using a mold (template or stamper) have been known as methods for producing microstructures. In particular, UV nanoimprinting can offer a high throughput and is very expected to be developed (see Patent Literature (PTL) 1 to 3). In the UV nanoimprinting, a photocurable composition is prepared as a precursor of a material to form the microstructure, applied to a substrate (base material), the applied photocurable composition is held against a mold, exposed to an ultraviolet ray to be cured, and thereby yields a cured product having a surface with a pattern corresponding to the mold.

Such method for producing a microstructure by nanoimprinting employs, for example, a quartz glass mold or a nickel mold. In general, these molds (transfer molds) have poor release properties (mold releasability) with respect to resins. To compensate this, the molds are coated with a mold-release agent on the surface before use. Independently, a silicone mold has been considered to be used as such mold, because the silicone has good mold releasability. The silicone is exemplified by polydimethylsiloxanes.

### CITATION LIST

### Patent Literature

PTL 1: U.S. Pat. No. 5,900,160

PTL 2: U.S. Pat. No. 5,925,259

PTL 3: U.S. Pat. No. 5,817,242

### SUMMARY OF INVENTION

### Technical Problem

However, when the quartz glass mold or nickel mold is used in continuous transfer, the mold-release agent is gradually separated from the mold (transfer mold). This requires a treatment with the mold-release agent (mold-release agent treatment) on occasion demands. In contrast, the silicone mold swells when used particularly in the case where the photocurable composition includes a radically polymerizable monomer as a component. Unfortunately, this impedes continuous transfer and causes, for example, lower productivity.

Accordingly, it is an object of the present invention to provide a method for producing a microstructure, where the method can perform continuous transfer with good mold releasability even without subjecting the mold to a surface release treatment.

It is another object of the present invention to provide a photocurable composition (photocurable composition for nanoimprinting) for use in the production of a microstructure by nanoimprinting using a mold, where the mold is formed from a polymeric organic compound containing siloxane bonds. The photocurable composition gives a cured product that enables continuous transfer with good mold releasability.

### Solution to Problem

After intensive investigations to achieve the objects, the present inventors have found a method for producing a microstructure by nanoimprinting, where the method employs a mold formed from a specific material and uses a specific photocurable composition; and have found that this production method can perform continuous transfer with good mold releasability without the need of a surface release treatment on the mold. The present invention has been made based on these findings.

Specifically, the present invention provides, in an aspect, a method for producing a microstructure. The method includes preparing a mold having a relief-patterned surface. Independently, a substrate is prepared. A liquid photocurable transferable material layer is formed and sandwiched between the substrate and the relief-patterned surface of the mold to be shaped. The shaped transferable material layer is exposed to be converted into a photocured layer. The photocured layer is then demolded (separated) from the mold to give the microstructure. The mold is prepared from a polymeric organic compound containing siloxane bonds. The transferable material layer is formed from a photocurable composition including a cationically polymerizable compound (A) and a photoacid generator (B). The cationically polymerizable compound (A) in the photocurable composition includes at least one compound selected from the group consisting of compounds represented by Formula (I) and compounds represented by Formula (II):

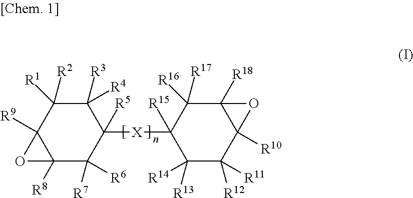

where n represents an integer from 0 to 10; X is, independently in each occurrence, selected from oxygen, —CH₂—, —C(CH₃)₂—, —CBr₂—, —C(CBr₃)₂—, —CF₂—, —C(CF₃)₂—, —CCl₂—, —C(CCl₃)—, and —CH(C₆H₅)—, where, when n is 2 or more, two or more occurrences of X may be identical or different; and R¹ to R¹⁸ are each, identically or differently, selected from hydrogen, halogen, a hydrocarbon group optionally containing oxygen or halogen, and optionally substituted alkoxy,

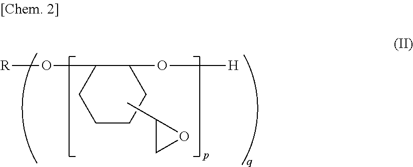

where R represents a group corresponding to a q-hydric alcohol, except for removing hydroxy group in a number of q from the alcohol; and p and q each represent, identically or differently, an integer of 1 or more.

In the method for producing a microstructure, the cationically polymerizable compound (A) in the photocurable composition may further include at least one compound selected from the group consisting of oxetanes, vinyl ethers, and epoxides excluding the compounds represented by Formula (I) and the compounds represented by Formula (II).

In the method for producing a microstructure, the cationically polymerizable compound (A) may contain a compound represented by Formula (III) in a content of from 0 to 80 percent by weight, where Formula (III) is expressed as follows:

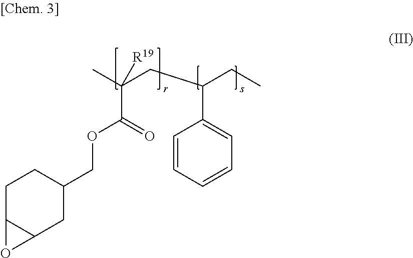

where R¹⁹ is, independently in each occurrence, selected from hydrogen and optionally substituted C₁-C₄ alkyl; and r and s each represent, identically or differently, an integer of 1 or more.

The present invention further provides, in another aspect, a photocurable composition for nanoimprinting. The photocurable composition is used to form a transferable material layer in the production of a microstructure. The production includes preparing a mold having a relief-patterned surface from a siloxane-bond-containing polymeric organic compound. Independently, a substrate is prepared. A liquid photocurable transferable material layer is formed from the photocurable composition and sandwiched between a substrate and the relief-patterned surface of the mold to be shaped. The shaped transferable material layer is exposed to be converted into a photocured layer. The photocured layer is then demolded (separated) from the mold. The photocurable composition includes a cationically polymerizable compound (A) and a photoacid generator (B). The cationically polymerizable compound (A) includes at least one compound selected from the group consisting of compounds represented by Formula (I) and compounds represented by Formula (II). Formulae (I) and (II) are expressed as follows:

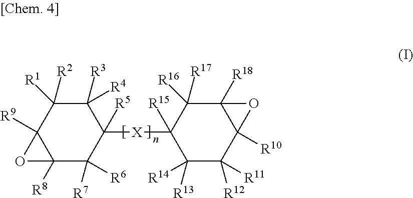

where n represents an integer from 0 to 10; X is, independently in each occurrence, selected from oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R³ are each, identically or differently, selected from hydrogen, halogen, a hydrocarbon group optionally containing oxygen or halogen, and optionally substituted alkoxy,

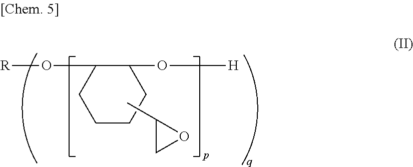

where R represents a group corresponding to a q-hydric alcohol, except for removing hydroxy group in a number of q from the alcohol; and p and q each represent, identically or differently, an integer of 1 or more.

In the photocurable composition for nanoimprinting, the cationically polymerizable compound (A) may further include at least one compound selected from the group consisting of oxetanes, vinyl ethers, and epoxides excluding the compounds represented by Formula (I) and the compounds represented by Formula (II).

In the photocurable composition for nanoimprinting, the cationically polymerizable compound (A) may include a compound represented by Formula (III) in a content of from 0 to 80 percent by weight, where Formula (III) is expressed as follows:

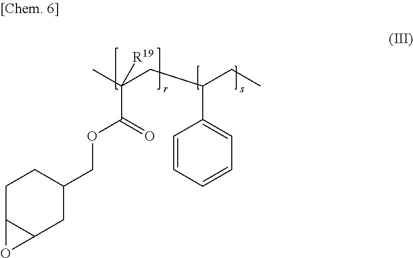

where R¹⁹ is, independently in each occurrence, selected from hydrogen and optionally substituted C₁-C₄ alkyl; and r and s each represent, identically or differently, an integer of 1 or more.

Specifically, the present invention relates to followings.

(1) The present invention relates to a method for producing a microstructure. The method includes preparing a mold having a relief-patterned surface. Independently, a substrate is prepared. A liquid photocurable transferable material layer is formed and sandwiched between the substrate and the relief-patterned surface of the mold to be shaped. The shaped transferable material layer is exposed to be converted into a photocured layer. The photocured layer is then demolded from the mold to yield the microstructure. The mold is prepared from a siloxane-bond-containing polymeric organic compound. The transferable material layer is formed from a photocurable composition including a cationically polymerizable compound (A) and a photoacid generator (B). The cationically polymerizable compound (A) in the photocurable composition includes at least one compound selected from the group consisting of compounds represented by Formula (I) and compounds represented by Formula (II), where Formulae (I) and (II) are expressed as follows:

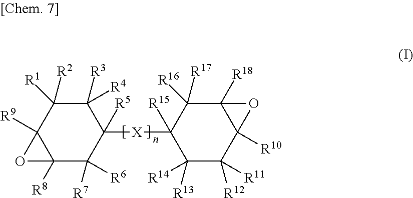

where n represents an integer from 0 to 10; X is, independently in each occurrence, selected from oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R¹⁸ are each, identically or differently, selected from hydrogen, halogen, a hydrocarbon group optionally containing oxygen or halogen, and optionally substituted alkoxy,

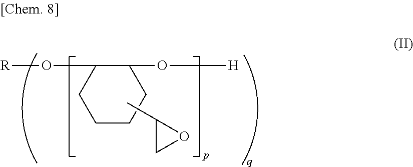

where R represents a group corresponding to a q-hydric alcohol, except for removing hydroxy group in a number of q from the alcohol; and p and q each represent, identically or differently, an integer of 1 or more.

(2) In the method for producing a microstructure according to (1), the cationically polymerizable compound (A) may include, as the compound represented by Formula (I), at least one compound selected from the group consisting of 3,4,3′,4′-diepoxybicyclohexyl, 2,2-bis(3,4-epoxycyclohexyl)propane, 2,2-bis(3,4-epoxycyclohexyl)-1,1,1,3,3,3-hexafluoropropane, bis(3,4-epoxycyclohexyl)methane, and 1,1-bis(3,4-epoxycyclohexyl)-1-phenylethane.

(3) In the method for producing a microstructure according to one of (1) and (2), the cationically polymerizable compound (A) may include, as the compound represented by Formula (II), one having a weight-average molecular weight (Mw) of from 500 to 10000 as determined and calibrated with a polystyrene standard.

(4) In the method for producing a microstructure according to any one of (1) to (3), the cationically polymerizable compound (A) in the photocurable composition may further include at least one compound selected from the group consisting of oxetanes, vinyl ethers, and epoxides excluding the compounds represented by Formula (I) and the compounds represented by Formula (II).

(5) In the method for producing a microstructure according to (4), the photocurable composition may include, as the epoxide, a compound represented by Formula (III):

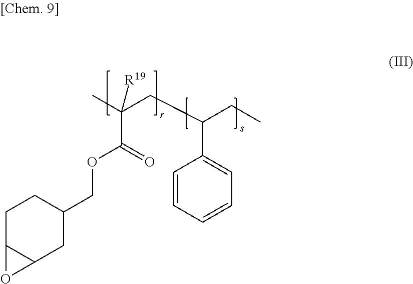

where R¹⁹ is, independently in each occurrence, selected from hydrogen and optionally substituted C₁-C₄ alkyl; and r and s each represent, identically or differently, an integer of 1 or more.

(6) In the method for producing a microstructure according to (5), the compound represented by Formula (III) may have a ratio (molar ratio) of the constitutional unit(s) in the brackets with r to the constitutional unit(s) in the brackets with s of from 10:90 to 90:10, where the ratio is indicated as [(constitutional unit(s) in the brackets with r):(constitutional unit(s) in the brackets with s)].

(7) In the method for producing a microstructure according to one of (5) and (6), the compound represented by Formula (III) may have a weight-average molecular weight (Mw) of from 1000 to 1000000 as determined and calibrated with a polystyrene standard.

(8) In the method for producing a microstructure according to any one of (4) to (7), the cationically polymerizable compound (A) may include a multifunctional oxetane as the oxetane.

(9) In the method for producing a microstructure according to any one of (4) to (8), the cationically polymerizable compound (A) may include a multifunctional vinyl ether as the vinyl ether.

(10) In the method for producing a microstructure according to any one of (1) to (9), the photocurable composition may contain the cationically polymerizable compound (A) in a content of from 50 to 99.5 percent by weight based on the total amount (100 percent by weight) of the photocurable composition. When the photocurable composition includes an organic solvent, the term “total amount” refers to the total amount of the photocurable composition excluding the organic solvent.

(11) In the method for producing a microstructure according to any one of (1) to (10), the cationically polymerizable compound (A) in the photocurable composition may contain the at least one compound selected from the group consisting of the compounds represented by Formula (I) and the compounds represented by Formula (II) in a content of 5 percent by weight or more based on the total amount (100 percent by weight) of the cationically polymerizable compound (A).

(12) In the method for producing a microstructure according to (11), the cationically polymerizable compound (A) may include 3,4,3′,4′-diepoxybicyclohexyl as the compound represented by Formula (I).

(13) In the method for producing a microstructure according to any one of (5) to (12), the cationically polymerizable compound (A) may contain the compound represented by Formula (III) in a content of from 0 to 80 percent by weight.

(14) In the method for producing a microstructure according to any one of (1) to (13), the photocurable composition may contain the photoacid generator (B) in a proportion of from 0.1 to 15 parts by weight per 100 parts by weight of the total amount of the cationically polymerizable compound (A).

(15) In the method for producing a microstructure according to any one of (1) to (14), the photocurable composition may include an antioxidant.

(16) In the method for producing a microstructure according to (15), the antioxidant may include at least one selected from the group consisting of phenolic antioxidants, phosphorus antioxidants, and sulfur antioxidants.

(17) In the method for producing a microstructure according to one of (15) and (16), the photocurable composition may contain the antioxidant in a proportion of from 0.001 to 15 parts by weight per 100 parts by weight of the total amount of the cationically polymerizable compound (A).

(18) In the method for producing a microstructure according to any one of (1) to (17), the photocurable composition may have a viscosity of from 1 to 1000000 mPa·s at 25° C.

(19) In the method for producing a microstructure according to any one of (1) to (18), the step of forming and sandwiching a liquid photocurable transferable material layer between the substrate and the relief-patterned surface of the mold to shape the transferable material layer may be performed by forming a photocurable transferable material layer on the substrate, and then placing or loading the mold on the formed photocurable transferable material layer. Alternatively, the step may be performed by forming a photocurable transferable material layer on the mold, and then placing or loading the substrate on the formed photocurable transferable material layer.

(20) In the method for producing a microstructure according to (19), the photocurable transferable material layer may be formed so as to have a thickness of from 10 to 100000 nm before placement of the mold or substrate.

(21) In the method for producing a microstructure according to one of (19) and (20), the placement of the mold or substrate on the photocurable transferable material layer may be performed with pressurization at a pressure of from 0.01 to 5 MPa.

(22) In the method for producing a microstructure according to (21), the pressurization is performed for a time of from 0.1 to 300 seconds.

(23) In the method for producing a microstructure according to one of (21) and (22), the photocurable transferable material layer may have a thickness of from 10 to 100000 nm after the placement of the mold or substrate with pressurization.

(24) In the method for producing a microstructure according to any one of (1) to (23), the exposure may be performed by irradiating the transferable material layer with an ultraviolet ray.

(25) In the method for producing a microstructure according to (24), the ultraviolet ray irradiation is performed at an integrated light quantity of from 100 to 100000 mJ/cm².

(26) The present invention also relates to a photocurable composition for nanoimprinting. The photocurable composition is used to form a transferable material layer in the production of a microstructure. The production includes preparing a mold having a relief-patterned surface from a siloxane-bond-containing polymeric organic compound. Independently, a substrate is prepared. A liquid photocurable transferable material layer is formed and sandwiched between the substrate and the relief-patterned surface of the mold to be shaped. The shaped transferable material layer is exposure to be converted into a photocured layer. The photocured layer is then demolded (separated) from the mold to give the microstructure. The photocurable composition includes a cationically polymerizable compound (A) and a photoacid generator (B). The cationically polymerizable compound (A) includes at least one compound selected from the group consisting of compounds represented by Formula (I) and compounds represented by Formula (II):

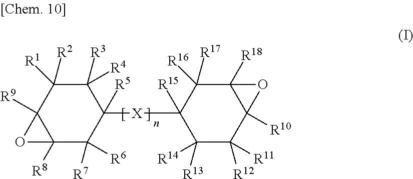

where n represents an integer from 0 to 10; X is, independently in each occurrence, selected from oxygen, —CH₂—, —C(CH₃)₂—, —CBr₂—, —C(CBr₃)—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R¹⁸ are each, identically or differently, selected from hydrogen, halogen, a hydrocarbon group optionally containing oxygen or halogen, and optionally substituted

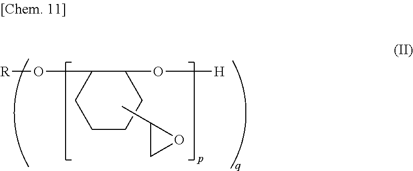

where R represents a group corresponding to a q-hydric alcohol, except for removing hydroxy group in a number of q from the alcohol; and p and q each represent, identically or differently, an integer of 1 or more.

(27) The photocurable composition for nanoimprinting according to (26) may include, as the compound represented by Formula (I), at least one compound selected from the group consisting of 3,4,3′,4′-diepoxybicyclohexyl, 2,2-bis(3,4-epoxycyclohexyl)propane, 2,2-bis(3,4-epoxycyclohexyl)-1,1,1,1,3,3,3-hexafluoropropane, bis(3,4-epoxycyclohexyl)methane, and 1,1-bis(3,4-epoxycyclohexyl)-1-phenylethane.

(28) The photocurable composition for nanoimprinting according to one of (26) and (27) may include, as the compound represented by Formula (II), one having a weight-average molecular weight (Mw) of from 500 to 10000 as determined and calibrated with a polystyrene standard.

(29) The cationically polymerizable compound (A) in the photocurable composition for nanoimprinting according to any one of any one of (26) to (28) may further include at least one compound selected from the group consisting of oxetanes, vinyl ethers, and epoxides excluding the compounds represented by Formula (I) and the compounds represented by Formula (II).

(30) The photocurable composition for nanoimprinting according to (29) may include, as the epoxide, a compound represented by Formula (III):

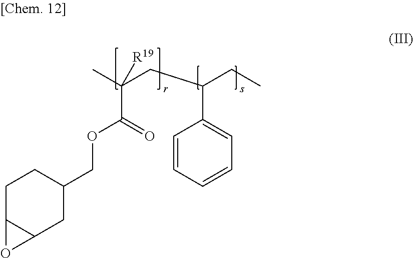

where R¹⁹ is, independently in each occurrence, selected from hydrogen and optionally substituted C₁-C₄ alkyl; and r and s each represent, identically or differently, an integer of 1 or more.

(31) In the photocurable composition for nanoimprinting according to (30), the compound represented by Formula (III) may have a ratio (molar ratio) of the constitutional unit in the brackets with r to the constitutional unit in the brackets with s of from 10:90 to 90:10. The ratio is expressed as [(constitutional unit in the brackets with r):(constitutional unit in the brackets with s)].

(32) In the photocurable composition for nanoimprinting according to one of (30) and (31), the compound represented by Formula (III) may have a weight-average molecular weight (Mw) of from 1000 to 1000000 as determined and calibrated with a polystyrene standard.

(33) The cationically polymerizable compound (A) in the photocurable composition for nanoimprinting according to any one of (29) to (32) may include a multifunctional oxetane as the oxetane.

(34) The cationically polymerizable compound (A) in the photocurable composition for nanoimprinting according to any one of (29) to (33) may include a multifunctional vinyl ether as the vinyl ether.

(35) The photocurable composition for nanoimprinting according to any one of (26) to (34) may contain the cationically polymerizable compound (A) in a content of from 50 to 99.5 percent by weight based on the total amount (100 percent by weight) of the photocurable composition. When the photocurable composition includes an organic solvent, the term “total amount” refers to the total amount of the photocurable composition excluding the organic solvent.

(36) The cationically polymerizable compound (A) in the photocurable composition for nanoimprinting according to any one of (26) to (35) may contain the at least one compound selected from the group consisting of the compounds represented by Formula (I) and the compounds represented by Formula (II) in a content of 5 percent by weight or more based on the total amount (100 percent by weight) of the cationically polymerizable compound (A).

(37) The cationically polymerizable compound (A) in the photocurable composition for nanoimprinting according to (36) may include 3,4,3′,4′-diepoxybicyclohexyl as the compound represented by Formula (I).

(38) The cationically polymerizable compound (A) in the photocurable composition for nanoimprinting according to any one of (30) to (37) may contain the compound represented by Formula (III) in a content of from 0 to 80 percent by weight.

(39) The photocurable composition for nanoimprinting according to any one of (26) to (38) may contain the photoacid generator (B) in a proportion of from 0.1 to 15 parts by weight per 100 parts by weight of the total amount of the cationically polymerizable compound (A).

(40) The photocurable composition for nanoimprinting according to any one of (26) to (39) may further include an antioxidant.

(41) In the photocurable composition for nanoimprinting according to (40), the antioxidant may include at least one selected from the group consisting of phenolic antioxidants, phosphorus antioxidants, and sulfur antioxidants.

(42) The photocurable composition for nanoimprinting according to one of (40) and (41) may contain the antioxidant in a proportion of from 0.001 to 15 parts by weight per 100 parts by weight of the total amount of the cationically polymerizable compound (A).

(43) The photocurable composition for nanoimprinting according to any one of (26) to (42) may have a viscosity of from 1 to 1000000 mPa·s at 25° C.

### Advantageous Effects of Invention

The method for producing a microstructure according to the present invention, as having the configuration, can perform continuous transfer with good mold releasability even without subjecting the mold to a surface release treatment and can produce a microstructure with high productivity. The photocurable composition for nanoimprinting according to the present invention may be used in a method for producing a microstructure by nanoimprinting using a mold formed from a siloxane-bond-containing polymeric organic compound. In this case, the photocurable composition enables continuous transfer with good mold releasability and enables the production of the microstructure with high productivity.

### BRIEF DESCRIPTION OF DRAWINGS

FIG. 1 depicts schematic diagrams (cross-sectional views) illustrating a method for producing a microstructure according to an embodiment of the present invention; and

FIG. 2 depicts schematic diagrams (cross-sectional views) illustrating an etching step and a resist-removing step in a method for producing a microstructure according to an embodiment of the present invention.

### DESCRIPTION OF EMBODIMENTS

The method for producing a microstructure according to the present invention is a method for producing a microstructure by nanoimprinting (nanoimprinting technology). The microstructure refers to a structure having a microstructure such as a relief pattern on a surface thereof. More specifically, the method for producing a microstructure according to the present invention is a method for producing a microstructure in which a liquid photocurable transferable material layer is formed and sandwiched between a substrate and a mold having a relief-patterned surface (fine relief pattern on the surface) to be shaped. The shaped photocurable transferable material layer is exposed to be cured to thereby be converted into a photocured layer, and the photocured layer is then demolded (released) from the mold. In the method for producing a microstructure according to the present invention, the step of forming and sandwiching the liquid photocurable transferable material layer between the substrate and the relief-patterned surface of the mold is referred to as “Step A”. Likewise, the step of performing exposure of the photocurable transferable material layer after Step A to convert the transferable material layer into a photocured layer and subsequently demolding the photocured layer from the mold is referred to as “Step B”. Specifically, the method for producing a microstructure according to the present invention is a production method essentially including Step A and Step B.

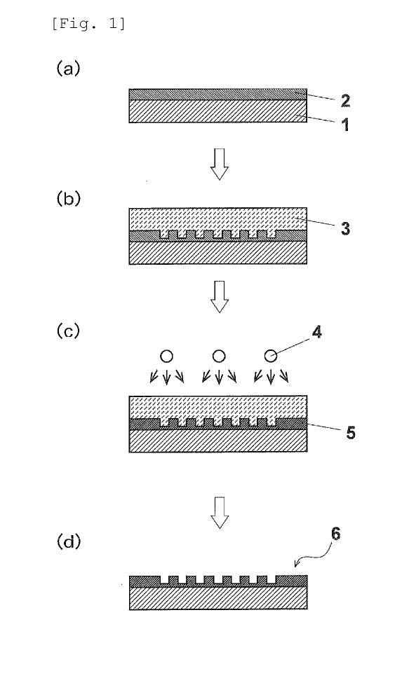

A method for producing a microstructure according to an embodiment of the present invention will be illustrated specifically with reference to FIG. 1. Initially, a photocurable transferable material layer (photocurable composition layer) 2 is prepared on one surface of a substrate 1 to give a structure as illustrated in FIG. 1(a). A mold 3 having a relief-patterned surface is placed on the surface of the photocurable transferable material layer 2 in the structure, and a pressure is applied as needed as illustrated in FIG. 1(b). This gives a structure in which the photocurable transferable material layer 2 is sandwiched and shaped between the substrate 1 and the mold 3. The photocurable transferable material layer 2 in the structure is then exposed to be cured to thereby form a photocured layer (cured product layer) 5 as illustrated in FIG. 1(c), and the photocured layer 5 is demolded (separated) from the mold 3 to give a microstructure 6 as illustrated in FIG. 1 (d).

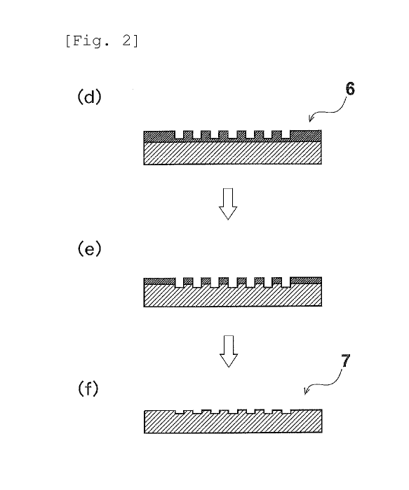

The method for producing a microstructure according to the present invention may further include one or more known or common micromachining steps on the resulting microstructure prepared through Step A and Step B. Such steps are exemplified by the step of etching, the step of removing the photocured layer (typically see FIG. 2), and liftoff step. This gives a structure including the substrate bearing a fine structure thereon. As used herein the term “microstructure (unetched)” refers to a microstructure before being etched; and the term “microstructure (after etching)” refers to a microstructure after being etched. The microstructure (unetched) and the microstructure (after etching) are also generically refers to a “microstructure obtained according to the present invention”.

The method for producing a microstructure according to the present invention prepares, as the mold, a mold from (including) a siloxane-bond-containing polymeric organic compound, i.e., prepares a mold including a siloxane-bond-containing polymeric organic compound. In addition, the method forms the photocurable transferable material layer from a specific photocurable composition. The photocurable composition includes a cationically polymerizable compound (A) and a photoacid generator (B) as essential components. The cationically polymerizable compound (A) includes a specific compound as an essential component. The specific compound is at least one compound selected from the group consisting of compounds represented by Formula (I) and compounds represented by Formula (II) as mentioned later. The method for producing a microstructure according to the present invention will be illustrated in detail below.

Step A

Step A in the method for producing a microstructure according to the present invention is the step of forming and sandwiching a liquid photocurable transferable material layer between a substrate and a relief-patterned surface of a mold, as described above.

Substrate

The substrate for use in the method for producing a microstructure according to the present invention may be selected from known or common substrates (base materials) without limitation. Such substrates are exemplified by glass substrates, silica glass substrates, sapphire substrates, plastic substrates (e.g., PET films, polycarbonate films, and triacetylcellulose films), silicon wafers, compound semiconductor substrates (e.g., GaAs, InAs, and GaN), metal substrates, and metal oxide substrates. The substrate may have undergone a known or common surface treatment.

Mold

The mold for use in the method for producing a microstructure according to the present invention acts as a template (stamper) for a microstructure and is a transfer stamp (stamper) for nanoimprinting, which stamp has a transfer pattern (relief pattern) including a fine relief on a surface thereof. The method for producing a microstructure according to the present invention employs, as the mold, a mold prepared from a siloxane-bond-containing polymeric organic compound, as described above. The siloxane-bond-containing polymeric organic compound is exemplified by organosilicon polymers (silicones) such as polydimethylsiloxanes (PDMSs) and polydimethylsiloxane rubbers. The method for producing a microstructure according to the present invention, as employing the mold formed from the siloxane-bond-containing polymeric organic compound as a mold, provides good release of a resin from the mold and enables easy demolding (separation) of the photocured layer from the mold in after-mentioned Step B. In addition, the mold can be prepared inexpensively, and this imparts cost advantages to the method for producing a microstructure according to the present invention.

The shape and size of the relief pattern in the mold can be set as appropriate depending on dimensions such as shape and size of the fine structure of the microstructure to be produced. The relief pattern may have sectional shapes of concavities (depressed portions) not limited, but exemplified by square, rectangular, semicircular, and triangle shapes, shapes analogous to these shapes, and indefinite shapes. The relief pattern may have a concavity depth (relief height) not critical, but preferably from 1 nm to 100 μm and a concavity opening width not critical, but preferably from 1 nm to 100 μm.

The mold may have undergone a known or common surface release treatment on its surface so as to have still better releasability from the photocured layer. The surface release treatment can be performed typically by a gas phase method or liquid phase method using a known or common mold release agent. The mold release agent is exemplified by perfluorinated polymeric compounds, hydrocarbon polymeric compounds, alkoxysilane compounds, trichlorosilane compounds, and diamond-like carbon. However, it should be noted that the method for producing a microstructure according to the present invention, as employing the mold, provides good releasability of the mold from the photocured layer even when no surface release treatment has been performed on the mold.

The mold may be prepared typically by pouring a precursor of a siloxane-bond-containing polymeric organic compound into a master template having a corresponding relief-patterned surface, and curing and shaping the precursor. The precursor is exemplified by a curable silicone resin composition.

Photocurable Transferable Material Layer (Photocurable Composition Layer)

The photocurable transferable material layer to be formed on the substrate in Step A is a liquid layer (photocurable composition layer) formed from (derived from) a liquid photocurable composition (photocurable composition for nanoimprinting). The photocurable composition includes a cationically polymerizable compound (A) and a photoacid generator (B) as essential components. The photocurable composition is also referred to as a “photocurable composition according to the present invention”.

Cationically Polymerizable Compound (A) The cationically polymerizable compound (A) in the photocurable composition according to the present invention is a compound containing one or more cationically polymerizable groups per molecule. The cationically polymerizable groups are exemplified by epoxy, vinyl ether, and oxetanyl groups. In particular, the cationically polymerizable compound (A) in the photocurable composition according to the present invention contains, as an essential component, at least one compound selected from the group consisting of compounds (cycloaliphatic epoxides) represented by Formula (I) and compounds (cycloaliphatic

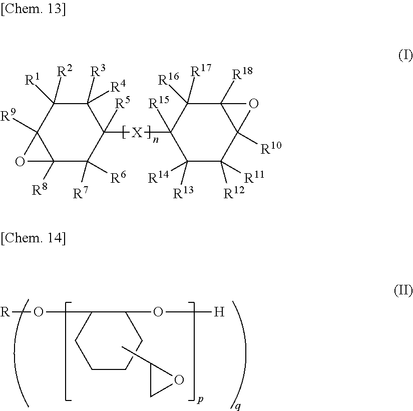

The compounds represented by Formula (I) are non-ester cycloaliphatic epoxides, i.e., cycloaliphatic epoxides being devoid of ester bonds in molecule. In Formula (I), n represents an integer from 0 to 10. X represents a divalent linkage group and is, independently in each occurrence, selected from oxygen, —CH₂—, —C(CH₃)₂—, —CBr₂—, —C(CBr₃)₂—, —CF₂—, —C(CF)₂—, —CCl₂—, —C(CCl₃)₂—, and —CH(C₆H₅)—, where, when n is 2 or more, two or more occurrences of X may be identical or different. When n is 0, the compound has a structure in which two cyclohexane rings in Formula (I) are linked to each other via a single bond.

In Formula (I), R¹ to R¹⁸ are each selected from hydrogen, halogen, a hydrocarbon group optionally containing oxygen or halogen, and optionally substituted alkoxy. R¹ to R¹⁸ may be identical or different. The halogen is exemplified by fluorine and chlorine. The hydrocarbon group and alkoxy may each contain carbon atom or atoms in a number not critical, but preferably from 1 to 5. Specifically, the hydrocarbon group and the alkoxy are respectively preferably a C₁-C₅ hydrocarbon group and C₁-C₅ alkoxy. The hydrocarbon group optionally containing oxygen or halogen is exemplified by alkoxyalkyl such as methoxyethyl; and haloalkyl such as trifluoromethyl. The optionally substituted alkoxy may have one or more substituents not limited, such as halogen, hydroxy, mercapto, carboxy, amino, mono- or di-alkylamino, mono- or di-phenylamino, glycidyl, epoxy, and isocyanato.

Of the compounds represented by Formula (I), particularly preferred are 3,4,3′,4′-diepoxybicyclohexyl, 2,2-bis(3,4-epoxycyclohexyl)propane, 2,2-bis(3,4-epoxycyclohexyl)-1,1,1,3,3,3-hexafluoropropane, bis(3,4-epoxycyclohexyl)methane, and 1,1-bis(3,4-epoxycyclohexyl)-1-phenylethane. Among them, 3,4,3′,4′-diepoxybicyclohexyl is preferred from the viewpoint of curability. The compounds represented by Formula (I) for use herein are also available as commercial products.

The photocurable composition according to the present invention may include each of different compounds represented by Formula (I) alone or in combination as the cationically polymerizable compound (A).

In Formula (II), R represents a group corresponding to q-hydric alcohol, except for removing hydroxy (—OH) groups in a number of q from the alcohol; and p and q each represent, identically or differently, an integer of 1 or more. The q-hydric alcohol [R—(OH)_{q}] is exemplified by polyhydric alcohols (e.g., C₁-C₁₅ alcohols) such as 2,2-bis(hydroxymethyl)-1-butanol. The number q is preferably from 1 to 6, and the number p is preferably from 1 to 30. When q is 2 or more, two or more occurrences of p in the group in the brackets (outer brackets) may be identical or different. Specifically, the compounds are exemplified by 1,2-epoxy-4-(2-oxiranyl)cyclohexane adduct of 2,2-bis(hydroxymethyl)-1-butanol (e.g., trade name EHPE3150, supplied by Daicel Corporation).

The compounds represented by Formula (II) may each have a weight-average molecular weight (Mw) not critical, but preferably from 500 to 10000, more preferably from 700 to 5000, and furthermore preferably from 1000 to 4000 as determined and calibrated with a polystyrene standard. The weight-average molecular weight may be measured typically by gel permeation chromatography (GPC).

The cationically polymerizable compound (A) in the photocurable composition according to the present invention may further include one or more other cationically polymerizable compounds. The term “other cationically polymerizable compounds” refers to cationically polymerizable compounds excluding the compounds represented by Formula (I) and the compounds represented by Formula (II). The other cationically polymerizable compounds are exemplified by epoxides excluding the compounds represented by Formula (I) and compounds represented by Formula (II); vinyl ethers; and oxetanes. The epoxides refer to compounds containing one or more epoxy groups per molecule. The vinyl ethers refer to compounds containing one or more vinyl ether groups per molecule. The oxetanes refer to compounds containing one or more oxetanyl groups per molecule.

The epoxides excluding the compounds represented by Formula (I) and the compounds represented by Formula (II) are also referred to as “other epoxides” and are exemplified by other cycloaliphatic epoxides; and glycidyl-containing epoxides (epoxy resins). The other cycloaliphatic epoxides refer to cycloaliphatic epoxides excluding the compounds represented by Formula (I) and the compounds represented by Formula (II) and containing a cyclic aliphatic group and an epoxy group in molecule. Among them, the other cycloaliphatic epoxides are preferred, of which particularly preferred are compounds containing an epoxy group (oxirane ring) including adjacent two carbon atoms constituting a cyclic aliphatic group. The other epoxides may each be either a monofunctional epoxide or a multifunctional epoxide, but are each preferably a multifunctional epoxide so as to give a microstructure with good precision. The term “monofunctional epoxide” refers to a compound containing one epoxy group per molecule. The term “multifunctional epoxide” refers to a compound containing two or more epoxy groups per molecule.

Of the other epoxides (other cycloaliphatic epoxides), preferred is a compound (copolymer) represented by Formula (III):

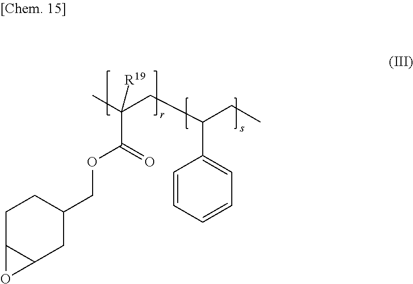

In Formula (III), r and s each represent, identically or differently, an integer of 1 or more (e.g., an integer from 1 to 100). R¹⁹ is, independently in each occurrence, selected from hydrogen and optionally substituted C₁-C₄ alkyl. The C₁-C₄ alkyl is exemplified by methyl, ethyl, propyl, isopropyl, butyl, s-butyl, and t-butyl. The substituent(s) which the alkyl may have is exemplified by halogen. The constitutional unit in the brackets with r and the constitutional unit in the brackets with s may be added (polymerized) to each other in a random form or block form. Specifically, the compound represented by Formula (III) may be a random copolymer or a block copolymer. The compound represented by Formula (III) may have a terminal structure not limited and may have, for example, a polymerization initiator terminus. The compound represented by Formula (III) may be prepared typically by polymerizing styrene with a compound represented by the following formula according to a known or common method. The formula is expressed as follows:

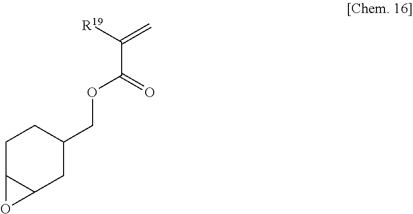

where R¹⁹ is as defined above.

The compound represented by Formula (III) may have a ratio (molar ratio) of the constitutional unit in the brackets with r to the constitutional unit in the brackets with s not critical, but preferably from 10:90 to 90:10, more preferably from 30:70 to 70:30, and furthermore preferably from 40:60 to 60:40. The both constitutional units constitute the compound represented by Formula (III). The ratio is expressed as [(constitutional unit in the brackets with r):(constitutional unit in the brackets with s)].

The compound represented by Formula (III) may have a weight-average molecular weight (Mw) not critical, but preferably from 1000 to 1000000, more preferably from 5000 to 500000, and furthermore preferably from 10000 to 100000, as determined and calibrated with a polystyrene standard. The weight-average molecular weight may be measured typically by gel permeation chromatography (GPC).

More specifically, the other epoxides are exemplified by bis(3,4-epoxycyclohexyl) adipate, 3,4-epoxycyclohexylmethyl(3,4-epoxy)cyclohexanecarboxylate, (3,4-epoxy-6-methylcyclohexyl)methyl 3′,4′-epoxy-6-methylcyclohexanecarboxylate, ethylene-1,2-bis(3,4-epoxycyclohexanecarboxylic acid) ester, 3,4-epoxycyclohexylmethyl alcohol, 1,2-epoxy-4-vinylcyclohexane, 1,2-epoxy-4-(2-methyloxiranyl)-1-methylcyclohexane, 1,2,5,6-diepoxycyclooctane, 2,2-bis(3′,4′-epoxycyclohexyl)propane, and glycidyl phenyl ether. The other cycloaliphatic epoxides are also available as commercial products typically under the trade names of CELLOXIDE 2000, CELLOXIDE 2021, and CELLOXIDE 3000 from Daicel Corporation.

In addition, the other epoxides are also available as commercial products typically under the trade name of 1031S from Mitsubishi Chemical Corporation; the trade names of TETRAD-X and TETRAD-C from MITSUBISHI GAS CHEMICAL COMPANY, INC.; and the trade name of EPB-13 from Nippon Soda Co., Ltd.

The vinyl ethers have only to be compounds containing at least one vinyl ether group per molecule. The vinyl ethers are not limited and may each be a monofunctional vinyl ether or a multifunctional vinyl ether. The monofunctional vinyl ether refers to a compound containing one vinyl ether group per molecule. The multifunctional vinyl ether refers to a compound containing two or more vinyl ether groups per molecule. Among them, multifunctional vinyl ethers are preferred from the viewpoint of precision of microstructure transfer.

Specifically, the vinyl ethers are exemplified by cyclic vinyl ethers (vinyl ethers containing a cyclic ether group such as oxirane ring, oxetane ring, or oxolane ring) such as isosorbide divinyl ether and oxanorbornene divinyl ether; aryl vinyl ethers such as phenyl vinyl ether; alkyl vinyl ethers such as n-butyl vinyl ether and octyl vinyl ether; cycloalkyl vinyl ethers such as cyclohexyl vinyl ether; and multifunctional vinyl ethers such as hydroquinone divinyl ether, 1,4-butanediol divinyl ether, cyclohexane divinyl ether, and cyclohexanedimethanol divinyl ether. The vinyl ethers for use herein are also exemplified by 2-hydroxyethyl vinyl ether (HEVE), diethylene glycol monovinyl ether (DEGV), 2-hydroxybutyl vinyl ether (HBVE), triethylene glycol divinyl ether (TEGDVE), and polyethylene glycol divinyl ether (PEGDVE). These may be available typically as products supplied by Maruzen Petrochemical Co., Ltd. The vinyl ethers for use herein are further exemplified by vinyl ethers containing one or more substituents at the alpha position and/or beta position (on carbon at the alpha position and/or beta position of ether oxygen). The substituents are exemplified by alkyl, aryl, and alkoxy.

The oxetanes have only to be compounds containing at least one oxetanyl group per molecule. The oxetanes are not limited and may each be either a monofunctional oxetane or a multifunctional oxetane. The monofunctional oxetane refers to a compound containing one oxetanyl group per molecule. The multifunctional oxetane refers to a compound containing two or more oxetanyl groups per molecule. Among them, multifunctional oxetanes are particularly preferred from the viewpoint of precision of microstructure transfer.

Specifically, the oxetanes are exemplified by 3-ethyl-3-(phenoxymethyl)oxetane (POX), di[1-ethyl(3-oxetanyl)]methyl ether (DOX), 3-ethyl-3-(2-ethylhexyloxymethyl)oxetane (EHOX), 3-ethyl-3-{[3-(triethoxysilyl)propoxy]methyl}oxetane (TESOX), oxetanylsilsesquioxane (OX-SQ), phenol novolac oxetane (PNOX-1009), 3-ethyl-3-hydroxymethyloxetane (OXA), 3-ethyl-3-(2-ethylhexyloxymethyl)oxetane (EHOX), 1,4-bis[(3-ethyl-3-oxetanylmethoxy)methyl]benzene (XDO), and 1,3-bis[(1-ethyl-3-oxetanyl)methoxy]benzene (RSOX). These may be available typically as products supplied by Toagosei Co., Ltd.

The other cationically polymerizable compounds for use herein are also exemplified by compounds containing two or more different cationically polymerizable groups per molecule, such as 3,3-dimethanol divinyl ether oxetane containing both an oxetanyl group and a vinyl ether group.

The photocurable composition according to the present invention may include each of different other cationically polymerizable compounds alone or in combination.

The photocurable composition according to the present invention may contain the cationically polymerizable compound (A) in a content (blending quantity) not critical, but preferably from 50 to 99.5 percent by weight, more preferably from 80 to 99 percent by weight, and furthermore preferably from 85 to 98 percent by weight, based on the total amount (100 percent by weight) of the photocurable composition. When the photocurable composition includes an organic solvent, the term “total amount” refers to the total amount of the photocurable composition excluding the organic solvent. The photocurable composition, if containing the cationically polymerizable compound (A) in a content less than 50 percent by weight, may undergo insufficient curing and may fail to give a pattern with good precision. In contrast, the photocurable composition, if containing the cationically polymerizable compound (A) in a content greater than 99.5 percent by weight, may undergo insufficient curing because of a relatively low content of the photoacid generator (B).

The photocurable composition according to the present invention may contain, as the cationically polymerizable compound (A), the at least one compound selected from the compounds represented by Formula (I) (in particular, 3,4,3′,4′-diepoxybicyclohexyl) and the compounds represented by Formula (II) in a content (blending quantity) not critical, but preferably 5 percent by weight or more (e.g., from 5 to 100 percent by weight), more preferably from 5 to 80 percent by weight, furthermore preferably from 7 to 60 percent by weight, and particularly preferably from 10 to 50 percent by weight, based on the total amount (100 percent by weight) of the cationically polymerizable compound (A). When the photocurable composition contains either one of the two compounds, the term “content” refers to the content of the one. The photocurable composition, if containing the at least one compound selected from the compounds represented by Formula (I) and the compounds represented by Formula (II) in a content less than 5 percent by weight, may undergo insufficient curing and may fail to give a pattern with good precision. In contrast, the photocurable composition, when containing the at least one compound selected from the compounds represented by Formula (I) and the compounds represented by Formula (II) in a content of 80 percent by weight or less, may often prevent the microstructure from embrittlement.

The photocurable composition may contain the compound represented by Formula (III) in a content (blending quantity) not critical, but preferably from 0 to 80 percent by weight, more preferably from 5 to 75 percent by weight, and furthermore preferably from 10 to 70 percent by weight, based on the total amount (100 percent by weight) of the cationically polymerizable compound (A). The photocurable composition, if containing the compound in a content greater than 80 percent by weight, may fail to give a pattern with good precision.

The method for producing a microstructure according to the present invention employs a photocurable composition including a cationically polymerizable compound (A) as the photocurable composition according to the present invention. The photocurable composition according to the present invention is a photocurable composition to form the photocurable transferable material layer. The method also employs a mold prepared from a siloxane-bond-containing polymeric organic compound as the mold. Owing to this combination use, the method enables transfer at a lower transfer pressure as compared with the case where a regular mold such as a quartz mold is used. The mold prepared from the siloxane-bond-containing polymeric organic compound, when used, eliminates the need of a surface release treatment on the mold. In addition, the mold prepared from the siloxane-bond-containing polymeric organic compound has high air permeability and helps the resulting microstructure to resist gas defects. In addition, the mold prepared from the siloxane-bond-containing polymeric organic compound has excellent conformability to the substrate (satisfactorily fits the shape of the substrate satisfactorily). Specifically, the method for producing a microstructure employs both the photocurable composition according to the present invention and the mold prepared from the siloxane-bond-containing polymeric organic compound. The method therefore gives a microstructure that excels both in productivity and quality. In contrast, if a radically curable composition including a radically polymerizable compound is used as a photocurable composition, the photocurable composition damages the mold prepared from the siloxane-bond-containing polymeric organic compound and impedes or disables the transfer.

In particularly preferred embodiments, the cationically polymerizable compound (A) in the photocurable composition according to the present invention may have any of formulations as follows:

[1] In an embodiment, the photocurable composition may include a cationically polymerizable compound (A) containing 15 to 45 percent by weight of the compound(s) represented by Formula (I) (in particular, 3,4,3′,4′-diepoxybicyclohexyl), 5 to 35 percent by weight of the compound(s) represented by Formula (II), and 5 to 25 percent by weight of the oxetane(s), based on the total amount (100 percent by weight) of the cationically polymerizable compound (A).

[2] In an embodiment, the photocurable composition may include a cationically polymerizable compound (A) containing 5 to 35 percent by weight of the compound(s) represented by Formula (I) (in particular, 3,4,3′,4′-diepoxybicyclohexyl), 55 to 85 percent by weight of the compound(s) represented by Formula (III), and 2 to 18 percent by weight of the oxetane(s), based on the total amount (100 percent by weight) of the cationically polymerizable compound (A).

[3] In an embodiment, the photocurable composition may include a cationically polymerizable compound (A) containing 5 to 35 percent by weight of the compound(s) represented by Formula (I) (in particular, 3,4,3′,4′-diepoxybicyclohexyl), 45 to 75 percent by weight of 1,2-epoxy-4-(2-methyloxiranyl)-1-methylcyclohexane, and 5 to 35 percent by weight of the oxetane(s), based on the total amount (100 percent by weight) of the cationically polymerizable compound (A).

[4] In an embodiment, the photocurable composition may include a cationically polymerizable compound (A) containing 15 to 45 percent by weight of the compound(s) represented by Formula (I) (in particular, 3,4,3′,4′-diepoxybicyclohexyl), 2 to 18 percent by weight of the compound(s) represented by Formula (II), and 35 to 65 percent by weight of the oxetane(s), based on the total amount (100 percent by weight) of the cationically polymerizable compound (A).

[5] In an embodiment, the photocurable composition may include a cationically polymerizable compound (A) containing 80 to 100 percent by weight of the compound(s) represented by Formula (II) based on the total amount (100 percent by weight) of the cationically polymerizable compound (A).

[6] In an embodiment, the photocurable composition may include a cationically polymerizable compound (A) containing 5 to 35 percent by weight of the compound(s) represented by Formula (I) (in particular, 3,4,3′,4′-diepoxybicyclohexyl), 55 to 85 percent by weight of the compound(s) represented by Formula (II), and 2 to 18 percent by weight of the oxetane(s), based on the total amount (100 percent by weight) of the cationically polymerizable compound (A).

Photoacid Generator (B)

The photoacid generator (B) in the photocurable composition according to the present invention is a compound that generates an acid upon the application of light and/or an active energy ray to proceed the curing reaction (cationic polymerization reaction) of the cationically polymerizable compound (A). The photoacid generator (B) for use herein may be selected from known or common photoacid generators and is exemplified by, but not limited to, sulfonium salts, iodonium salts, phosphonium salts, and pyridinium salts. The photocurable composition according to the present invention may include each of different photoacid generates alone or in combination as the photoacid generator (B).

The sulfonium salts are exemplified by triphenylsulfonium hexafluorophosphate, triphenylsulfonium hexafluoroantimonate, bis(4-(diphenylsulfonio)-phenyl)sulfide bis(hexafluorophosphate), bis(4-(diphenylsulfonio)-phenyl)sulfide bis(hexafluoroantimonate), 4-di(p-toluyl)sulfonio-4′-tert-butylphenylcarbonyl-diphenyl sulfide hexafluoroantimonate, 7-di(p-toluyl)sulfonio-2-isopropylthioxanthone hexafluorophosphate, 7-di(p-toluyl)sulfonio-2-isopropylthioxanthone hexafluoroantimonate, and aromatic sulfonium salts described typically in JP-A No. H06-184170, JP-A No. H07-61964, JP-A No. H08-165290, U.S. Pat. No. 4,231,951, and U.S. Pat. No. 4,256,828.

The iodonium salts are exemplified by diphenyliodonium hexafluorophosphate, diphenyliodonium hexafluoroantimonate, bis(dodecylphenyl)iodonium tetrakis(pentafluorophenyl)borate, and aromatic iodonium salts described typically in JP-A No. H06-184170 and U.S. Pat. No. 4,256,828.

The phosphonium salts are exemplified by tetrafluorophosphonium hexafluorophosphate, tetrafluorophosphonium hexafluoroantimonate, and aromatic phosphonium salts described typically in JP-A No. H06-157624.

The pyridinium salts are exemplified by pyridinium salts described typically in Japanese Patent No. 2519480 and JP-A No. H05-222112.

The photoacid generator (B) may contain an anion. The anion is exemplified by, but not limited to, SbF₆⁻ and a borate represented by Formula (1):

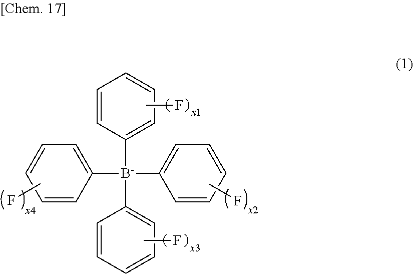

where X1 to X4 each independently represent an integer from 0 to 5, and the total sum of X1 to X4 is 1 or more. The borate is exemplified by tetrakis(pentafluorophenyl)borate.

The sulfonium salts and iodonium salts are also readily commercially available. Such readily commercially available photoacid generators (B) are exemplified by sulfonium salts available under the trade names of UVI-6990 and UVI-6974 (each from Union Carbide Corporation), the trade names of ADEKA OPTOMER SP-170 and ADEKA OPTOMER SP-172 (each from ADEKA CORPORATION), and the trade names of CPI-100P, CPI-100A, CPI-200K, CPI-300PG, and HS-1PC (each from San-Apro Ltd.); and iodonium salts available under the trade name of PI 2074 (from Rhodia).

The photocurable composition according to the present invention may contain the photoacid generator (B) in a proportion (blending quantity) not critical, but preferably from 0.1 to 15 parts by weight, and more preferably from 1 to 12 parts by weight, per 100 parts by weight of the total amount of the cationically polymerizable compound (A). The photocurable composition, if containing the photoacid generator (B) in a proportion less than 0.1 part by weight, may cause the photocured layer to undergo insufficient curing. In contrast, the photocurable composition, if containing the photoacid generator (B) in a proportion greater than 15 parts by weight, may cause the photocured layer to be susceptible to coloration.

Other Components Such as Additives

The photocurable composition according to the present invention preferably includes an antioxidant. The antioxidant for use herein may be selected from known or common antioxidants and is exemplified by, but not limited to, phenolic antioxidants, phosphorus antioxidants, and sulfur antioxidants. The photocurable composition may include each of different antioxidants alone or in combination.

The phenolic antioxidants are exemplified by monophenols such as 2,6-di-t-butyl-p-cresol, butylated hydroxyanisole, 2,6-di-t-butyl-p-ethylphenol, and stearyl β-(3,5-di-t-butyl-4-hydroxyphenyl)propionate; bisphenols such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol), and 3,9-bis[1,1-dimethyl-2-{1-(3-t-butyl-4-hydroxy-5-methylphenyl)propionyloxy}ethyl]-2,4,8,10-tetraoxaspiro[5.5]undecane; and high-molecular phenols such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl) propionate]methane, bis[3,3′-bis-(4′-hydroxy-3′-t-butylphenyl)butyric acid]glycol ester, 1,3,5-tris(3′,5′-di-t-butyl-4′-hydroxybenzyl)-s-triazine-2,4,6-(1H,3H,5H)trione, and tocopherol.

The phosphorus antioxidants are exemplified by phosphites such as triphenyl phosphite, diphenyl isodecyl phosphite, phenyl diisodecyl phosphite, tris(nonylphenyl)phosphite, diisodecyl pentaerythritol phosphite, tris(2,4-di-t-butylphenyl)phosphite, cyclic neopentanetetrayl bis(octadecyl)phosphite, cyclic neopentanetetrayl bis(2,4-di-t-butylphenyl)phosphite, cyclic neopentanetetrayl bis(2,4-di-t-butyl-4-methylphenyl)phosphite, and bis[2-t-butyl-6-methyl-4-{2-(octadecyloxycarbonyl)ethyl}phenyl]hydrogen phosphite; and oxaphosphaphenanthrene oxides such as 9,10-dihydro-9-oxa-10-phosphaphenanthrene-10-oxide and 10-(3,5-di-t-butyl-4-hydroxybenzyl)-9,10-dihydro-9-oxa-10-phosphaphenanthrene-10-oxide.

The sulfur antioxidants are exemplified by dilauryl 3,3′-thiodipropionate, dimyristyl-3,3′-thiodipropionate, and distearyl-3,3′-thiodipropionate.

The antioxidant for use herein may also available as commercial products.

The photocurable composition according to the present invention may contain the antioxidant in a proportion (blending quantity) not critical, but preferably from 0.001 to 15 parts by weight, more preferably from 0.01 to 10 parts by weight, and furthermore preferably from 0.1 to 5 parts by weight, per 100 parts by weight of the total amount of the cationically polymerizable compound (A). The photocurable composition, if containing the antioxidant in a proportion less than 0.001 part by weight, may fail to sufficiently restrain the photocured layer from deteriorating in some uses. In contrast, the photocurable composition, if containing the antioxidant in a proportion greater than 15 parts by weight, may cause the photocured layer to undergo curing insufficiently.

The photocurable composition according to the present invention may contain an organic solvent as needed. The organic solvent for use herein may be selected from known or common organic solvents and is exemplified by, but not limited to, ketones such as methyl ethyl ketone and cyclohexanone; aromatic hydrocarbons such as toluene, xylenes, and tetramethylbenzene; glycol ethers such as CELLOSOLVE, Methyl CELLOSOLVE, CARBITOL, Methyl CARBITOL, Butyl CARBITOL, propylene glycol monomethyl ether, dipropylene glycol monomethyl ether, dipropylene glycol monoethyl ether, and triethylene glycol monoethyl ether; acetic acid esters such as ethyl acetate, butyl acetate, CELLOSOLVE Acetate, Butyl CELLOSOLVE Acetate, CARBITOL Acetate, Butyl CARBITOL Acetate, and propylene glycol monomethyl ether acetate; alcohols such as ethanol, propanol, ethylene glycol, and propylene glycol; aliphatic hydrocarbons such as octane and decane; and petroleum solvents such as petroleum ether, petroleum naphtha, hydrogenated petroleum naphtha, and solvent naphtha. The photocurable composition may include each of different organic solvents alone or in combination as the organic solvent.

The photocurable composition according to the present invention may contain the organic solvent in a content (blending quantity) not critical, but preferably from 0 to 95 percent by weight and more preferably from 0 to 80 percent by weight based on the total amount (100 percent by weight) of the photocurable composition. The organic solvent, when contained in the photocurable composition according to the present invention, is preferably removed before the exposure of the photocurable transferable material layer.

The photocurable composition according to the present invention may include nano-scale particles. As the nano-scale particles, any of polymerizable silanes and/or condensates derived from them may be added. The polymerizable silanes are exemplified by a compound represented by Formula (2) and a compound represented by Formula (3):

SiU₄ (2)

where Group U is, identically or differently in each occurrence, selected from a hydrolyzable group and hydroxy,

R²¹ₐR²²_{b}SiU_{(4-a-b)} (3)

where R²¹ represents a non-hydrolyzable group; R²² represents a group containing a functional group; U is as defined above; and “a” and “b” each represent a value selected from 0, 1, 2, and 3, where the total (a+b) of “a” and “b” is a value selected from 1, 2, and 3.

The nano-scale particles are further exemplified by nano-scale particles including at least one selected from the group consisting of oxides, sulfides, selenides, tellurides, halides, carbides, arsenides, antimonides, nitrides, phosphides, carbonates, carboxylates, phosphates, sulfates, silicates, titanates, zirconates, aluminates, stannates, plumbates, and mixed oxides of them.

More specifically, the nano-scale particles are exemplified by nano-scale inorganic particles disclosed in PCT International Publication Number WO96/31572. The nano-scale inorganic particles are exemplified by particles of oxides such as CaO, ZnO, CdO, SiO₂, TiO₂, ZrO₂, CeO₂, SnO₂, PbO, AlO, In₂O₃, and La₂O₃; sulfides such as CdS and ZnS; selenides such as GaSe, CdSe, and ZnSe; tellurides such as ZnTe and CdTe; halides such as NaCl, KCl, BaCl₂, AgCl, AgBr, AgI, CuCl, CuBr, CdI₂, and PbI₂; carbides such as CeC₂; arsenides such as AlAs, GaAs, and CeAs; antimonides such as InSb; nitrides such as BN, AlN, Si₃N₄, and Ti₃N₄; phosphides such as GaP, InP, Zn₃P₂, and Cd₃P₂; carbonates such as Na₂CO₃, K₂CO₃, CaCO₃, SrCO₃, and BaCO₃; carboxylates including acetates such as CH₃COONa and Pb(CH₃COO)₄; phosphates; sulfates; silicates; titanates; zirconates; aluminates; stannates; plumbates; and mixed oxides whose compositions preferably correspond to the composition of common glass with a low coefficient of thermal expansion, such as binary, ternary, or quaternary combinations of SiO₂, TiO₂, ZrO₂, and Al₂O₃.

The nano-scale particles may be prepared by a conventional process such as flame hydrolysis, flame pyrolysis, or plasma process as in literature described in PCT International Publication Number WO 96/31572. Among them, the nano-scale particles herein are particularly preferably stabilized colloidal, nanodisperse sols of inorganic particles, such as silica sols available from BAYER AG, SnO₂ sols available from Goldschmidt AG, TiO₂ sols available from Merck KGaA, SiO₂, ZrO₂, Al₂O₃, and Sb₂O₃ sols available from Nissan Chemicals, and Aerosil dispersions available from DEGUSSA AG.

The nano-scale particles may have an average particle diameter not critical, but preferably from 1 to 200 nm, more preferably from 2 to 50 nm, and furthermore preferably from 2 to 20 nm.

The photocurable composition according to the present invention may contain the nano-scale particles in a content (volume fraction) not critical, but preferably from 0 to 50 percent by volume, more preferably from 0 to 30 percent by volume, and furthermore preferably from 0 to 20 percent by volume, based on the total amount (100 percent by volume) of the photocurable composition.

The photocurable composition according to the present invention may include, as needed, a compound (fluorosilane) represented by Formula (4):

R²³(U¹)₃Si (4)

where R²³ represents partially fluorinated or perfluorinated C₂-C₂₀ alkyl; and U¹ is, identically or differently in each occurrence, selected from C₁-C₄ alkoxy, methyl, ethyl, and chlorine.

The term “partially fluorinated alkyl” refers to alkyl with at least one hydrogen atom replaced with a fluorine atom. As the group R²³, particularly preferred are CF₃CH₂CH₂—, C₂F₅CH₂CH₂—, C₄F₉CH₂CH₂—, n-C₆F₁₃CH₂CH₂—, n-C₈F₁₇CH₂CH₂—, n-C₁₀F₂₁CH₂CH₂—, and i-C₃F₇O—(CH₂)₃—.

Of such compounds represented by Formula (4), those available as commercial products include tridecafluoro-1,1,2,2-tetrahydrooctyl-1-triethoxysilane, CF₃CH₂CH₂SiCl₂CH₃, CF₃CH₂CH₂SiCl(CH₃)₂, CF₃CH₂CH₂Si(CH₃)(OCH₃)₂, i-C₃F₇O—(CH₂)₃SiCl₂CH₃, n-C₆F₁₃CH₂CH₂SiCl₂CH₃, and n-C₆F₁₃CH₂CH₂SiCl(CH₃)₂.

The photocurable composition according to the present invention may contain the compound represented by Formula (4) in a content (blending quantity) not critical, but preferably from 0 to 3 percent by weight, more preferably from 0.05 to 3 percent by weight, furthermore preferably from 0.1 to 2.5 percent by weight, and particularly preferably from 0.2 to 2 percent by weight, based on the total amount (100 percent by weight) of the photocurable composition.

The photocurable composition according to the present invention is a liquid photocurable composition. The photocurable composition according to the present invention is not limited, as long as being liquid at any temperature, but is particularly preferably liquid at room temperature (e.g., 25° C.). Specifically, the photocurable transferable material layer is preferably a layer that is liquid at room temperature (e.g., 25° C.). The photocurable composition according to the present invention, when being a liquid composition at room temperature, can easily form the photocurable transferable material layer on the substrate at room temperature and enables easy and highly precise transfer (nanoimprinting) of the mold relief pattern to the photocurable transferable material layer.

Specifically, the photocurable composition according to the present invention may have a viscosity at 25° C. not critical, but preferably from 1 to 1000000 mPa·s, more preferably from 2 to 10000 mPa·s, and furthermore preferably from 3 to 1000 mPa·s. The photocurable composition, if having a viscosity less than 1 mPa·s at 25° C., may cause the resulting photocurable transferable material layer to hardly remain as a layer. In contrast, the photocurable composition, if having a viscosity greater than 1000000 mPa·s at 25° C., may cause less precise transfer of the mold relief pattern to the photocurable transferable material layer. The viscosity at 25° C. may be measured typically using an E-type viscometer (trade name VISCONIC, supplied by Tokimec, Inc.) with a rotor of 1°34′×R24 at a number of revolutions of 0.5 rpm and a measurement temperature of 25° C.

In Step A of the method for producing a microstructure according to the present invention, the liquid photocurable transferable material layer is sandwiched between the substrate and the relief-patterned surface of the mold. In Step A, the laminated structure including the substrate, the photocurable transferable material layer, and the mold disposed in this order may be obtained by a process not limited. Typically, the process is exemplified by a process in which the photocurable composition according to the present invention is applied to the substrate by a known or common coating process to form the photocurable transferable material layer (photocurable composition layer), and the mold is placed on the formed photocurable transferable material layer; and a process in which the photocurable composition according to the present invention is applied to the mold to form the photocurable transferable material layer, and the substrate is placed on the formed photocurable transferable material layer. The coating process is exemplified by spin coating, slit coating, spray coating, and roller coating. In an embodiment, the photocurable composition according to the present invention contains an organic solvent. In this embodiment, after the photocurable composition is applied to the substrate or mold, the organic solvent may be vaporized and removed with heating as needed to form the photocurable transferable material layer.

Before the placement of the mold or substrate, the photocurable transferable material layer may have a thickness not critical, but preferably from 10 to 100000 nm (e.g., 50 to 100000 nm), and more preferably from 100 to 50000 nm. The photocurable transferable material layer, if having a thickness less than 10 nm, may have insufficient curability. In contrast, the photocurable transferable material layer, if having a thickness greater than 100000 nm, may cause the photocured layer after nanoimprinting to remain in excess.

The mold or substrate is placed (loaded) on the photocurable transferable material layer preferably with the application of pressure so as to satisfactorily precisely transfer the mold relief pattern to the photocurable transferable material layer. The application of pressure may be performed from either one or both of the mold and substrate sides. The pressure (load) to be applied is not critical, but preferably from 0.01 to 5 MPa, more preferably from 0.03 to 3 MPa, and furthermore preferably from greater than 0.05 MPa to 1 MPa. The pressure application, if performed at a pressure less than 0.01 MPa or greater than 5 MPa, may cause less precise transfer of the relief pattern. The pressure application may be performed for a time (pressure application time) not critical, but preferably from 0.1 to 300 seconds, more preferably from 0.2 to 200 seconds, and particularly preferably from 0.5 to 100 seconds. The pressure application, if performed for a time shorter than 0.1 second, may cause less precise transfer of the relief pattern. In contrast, the pressure application, if performed for a time longer than 300 seconds, may cause the microstructure to be produced with inferior productivity.

After the placement of the mold or substrate and the pressure application, the photocurable transferable material layer may have a thickness not critical, but preferably from 10 to 100000 nm (e.g., from 50 to 100000 nm), and more preferably from 100 to 50000 nm. The photocurable transferable material layer, if having a thickness less than 10 nm, may have insufficient curability. In contrast, the photocurable transferable material layer, if having a thickness greater than 100000 μm, may cause the photocured layer after nanoimprinting to remain in excess.

Step A gives a structure including the photocurable transferable material layer sandwiched between the substrate and the mold, i.e., a structure having a laminated structure including the substrate, the photocurable transferable material layer, and the mold laminated in this order, as mentioned above.

Step B

The method for producing a microstructure according to the present invention includes Step B performed after Step A. In Step B, exposure of the photocurable transferable material layer in the structure is performed to convert the layer into a photocured layer, and the photocured layer is released or demolded from the mold.

The exposure of the photocurable transferable material layer may be performed by any known or common process not limited. The light to be applied upon exposure is exemplified by X rays, ultraviolet rays, visible light, infrared rays (including near-infrared rays and far-infrared rays), and electron beams. Among them, ultraviolet rays are preferred for easy handling. The light source for the light is exemplified by, but not limited to, mercury lamps, xenon lamps, carbon arc lamps, metal halide lamps, sunlight, electron beam sources, laser sources, and LED light sources. The exposure of the photocurable transferable material layer may be performed under conditions that are controllable as appropriate and are not critical. Typically, in an embodiment, the exposure is performed by ultraviolet irradiation. In this embodiment, the exposure is preferably performed by applying an ultraviolet ray at an integrated light quantity (integrated exposure) of from 100 to 100000 mJ/cm², and more preferably from 100 to 50000 mJ/cm².

The method may further include a heat treatment upon the exposure of the photocurable transferable material layer. The heat treatment, when performed, may enable the formation of a photocured layer with a higher degree of cure (curing rate) in an exposed (irradiated) portion, and this may allow the resulting microstructure to have excellent heat resistance. The heat treatment may be performed simultaneously or concurrently with, or before or after the exposure. The heat treatment, when performed after the exposure, may be performed before and/or after the demolding. The heating may be performed at a temperature not critical, but preferably from 80° C. to 150° C. and may be performed for a time not critical, but preferably from 1 to 10 minutes.

The exposure of the photocurable transferable material layer may be performed in any atmosphere not limited, as long as not adversely affecting the curing reaction. The atmosphere may be any typically of air, nitrogen, and argon atmospheres. The exposure may be performed under normal atmospheric pressure, under reduced pressure, or under pressure (under a load).

The exposure gives a structure including a photocured layer converted from the photocurable transferable material layer. The photocured layer includes a cured product of the photocurable composition according to the present invention. The resulting structure has a laminate structure including the substrate, the photocured layer, and the mold laminated in this order. In Step B, the structure is then demolded (separated) from the mold. The method for producing a microstructure according to the present invention employs, as the mold, a mold prepared from a siloxane-bond-containing polymer and thereby enables easy demolding even without subjecting the mold to a surface release treatment typically with a mold-release agent. The method also employs, as the photocurable transferable material layer, a specific transferable material layer formed from the photocurable composition according to the present invention and thereby enables easy, continuous transfer without causing the mold to swell. The way to demold (to separate the mold) is not limited and is exemplified by a manual demolding process of stripping the mold typically by hand or with tweezers; and an automatic demolding process using a tool for micromolding (e.g., a tool supplied by SUSS MicroTec, Inc. of Indianapolis, Ind. 46204, U.S.A.).

Step B gives a microstructure (unetched) including a substrate and a photocured layer disposed on the surface of the substrate, where the photocured layer has the mold relief pattern imprinted thereon. The photocured layer (cured coating) in the microstructure [microstructure (unetched)] may have a thickness not critical, but preferably from 50 to 1000 nm, and more preferably from 100 to 500 nm.

The microstructure (unetched) generally includes, on the substrate, not only the imprinted fine structure, but also a residual, unstructured coating layer having a thickness of less than 30 nm. The residual layer is preferably removed so as to achieve a steep wall slope and a high aspect ratio. The residual layer can be removed typically through an after-mentioned etching step. Whether the residual layer remains can be detected typically using a scanning electron microscope.

In addition to Step A and Step B, the method for producing a microstructure according to the present invention may further include an etching step. The etching step is the step of subjecting the photocured layer (cured coating) and the substrate to etching. The etching may be performed by a known or common process that is not limited, such as a process of using oxygen plasma or a CHF₃/O₂ gas.

The etching step gives a microstructure (after etching). After the etching, the residual photocured layer (resist coating) remaining in the microstructure obtained according to the present invention can be removed typically using a known or common solvent such as tetramethylammonium hydroxide. Specifically, the method for producing a microstructure according to the present invention may further include the above-mentioned resist-removing step of removing the photocured layer.

FIG. 2 depicts schematic diagrams (cross-sectional views) illustrating an etching step and a resist-removing step in a method for producing a microstructure according to an embodiment of the present invention. Through Step A and Step B in the method for producing a microstructure according to the present invention, a microstructure (unetched) 6 is obtained. The microstructure (unetched) 6 is subjected to etching (see FIG. 2(e)), and a residual photocured layer (coating) is removed as needed to yield a microstructure (after etching) 7 (see FIG. 2(f)).

The method for producing a microstructure according to the present invention may further include, in addition to or instead of the etching step and/or the resist step, one or more other steps. Such other steps are exemplified by the step of doping a semiconductor material in an etched region of the substrate. The substrate herein is exemplified by a compound semiconductor substrate.

The method for producing a microstructure according to the present invention gives a microstructure (microstructure obtained according to the present invention). The microstructure is produced using the mold prepared from a siloxane-bond-containing polymeric organic compound and using a layer formed from the photocurable composition according to the present invention as the photocurable transferable material layer. The microstructure thereby has good mold releasability and can be produced with extremely high productivity because the method enables continuous transfer. The microstructure obtained according to the present invention is usable in a variety of areas where microstructures obtained by nanoimprinting are used. The microstructure is extremely useful typically in the areas of semiconductor materials, flat screens, holograms, waveguides, media-use structures, precision machinery components, and sensors and other precision machinery components.

### EXAMPLES

The present invention will be illustrated in further detail with reference to several examples below. It should be noted, however, that the examples are by no means intended to limit the scope of the present invention. In Table 1, the amounts of individual components constituting photocurable compositions are given in part by weight.

### Example 1

### Preparation of Photocurable Composition

Materials were prepared as 20 parts by weight of EHPE3150 (trade name; supplied by Daicel Corporation), 20 parts by weight of jER YX8000 (trade name; supplied by Mitsubishi Chemical Corporation), 30 parts by weight of 3,4,3′,4′-diepoxybicyclohexyl, 15 parts by weight of CELLOXIDE 2021P (trade name; supplied by Daicel Corporation), 15 parts by weight of OXT221 (trade name; supplied by Toagosei Co., Ltd.), 6 parts by weight of HS-1PC (trade name; supplied by San-Apro Ltd.), and 0.1 part by weight of methoxyhydroquinone (MEHQ). The materials were mixed and stirred at room temperature (25° C.) to dissolve the individual components uniformly and yielded a photocurable composition (photocurable composition for nanoimprinting) being liquid at room temperature.

Production of Microstructure

Using the above-prepared photocurable composition, a microstructure was produced by a procedure as follows.

Initially, a substrate was prepared as a 25 mm×25 mm square silicon wafer pretreated with hexamethyldisilazane. The above-prepared photocurable composition was applied to the substrate by spin coating at 3000 revolutions for 30 seconds and formed a coating of the composition as a photocurable transferable material layer. The coating had a thickness (layer thickness) of about 500 nm.

Next, the substrate bearing the above-obtained photocurable transferable material layer was placed on the stage of an imprinter (Model NM-0403; supplied by Meisho Kiko Co.), and a finely-patterned silicone mold was placed on the photocurable transferable material layer, where the silicone was a polydimethylsiloxane (PDMS). The transfer pressure (applied pressure) was then increased up to 0.1 MPa over 30 seconds and held at that level for a pressure application time given in Table 1. While maintaining the transfer pressure at that level, an ultraviolet ray was applied to the article from the mold surface at an UV irradiation intensity for an UV irradiation time each given in Table 1 and at an integrated light quantity of 660 mJ/cm² to cure the photocurable transferable material layer and thereby yielded a nanoimprinted cured product layer (photocured layer). The mold herein is a mold capable of transferring a 200-nm wide line-and-space pattern. The imprinter is a testing machine under computer control, where the machine can maintain a specified pressure for a specific time by programming conditions such as loading, relaxation rate, and heating temperature. In addition, the machine can apply an ultraviolet ray using an attendant high-pressure mercury lamp.

Subsequently the photocured layer was demolded by stripping off the mold from the photocured layer typically with tweezers and yielded a microstructure including the substrate and the patterned photocured layer on the substrate.

### Examples 2 to 7 and Comparative Examples 1 to 4

A photocurable composition was prepared by the procedure of Example 1, except for employing another blending formulation of the photocurable composition as given in Table 1. In addition, a microstructure was produced by the procedure of Example 1, except for using a photocurable composition as given in Table 1 and employing transfer conditions as given in Table 1.

In Examples 3, 6, and 7, the photocurable transferable material layer was dried at 80° C. for 10 minutes upon its formation to remove the organic solvent (PGMEA). In Comparative Examples 3 and 4, employed was a quartz mold which had undergone a surface release treatment.

Mold Releasability Evaluation

In the examples and comparative examples, the mold after microstructure production was visually observed on the patterned surface, based on which the mold releasability was evaluated according to criteria as follows:

Good (good mold releasability): No resin (cured product of the photocurable composition) was attached to or deposited on the mold; and

Poor (poor mold releasability): The resin (cured product of the photocurable composition) was attached to the mold.

Transferability Evaluation

The transfer rate of each of the microstructures obtained in the examples and comparative examples was calculated, based on which the transferability was evaluated according to the following criteria, where the transferability is a property indicating how precisely the mold pattern is replicated in the microstructure.

Excellent (very good transferability): Having a transfer rate of 70% or more;

Good (good transferability): Having a transfer rate of from 30% to less than 70%; and

Poor (poor transferability): Having a transfer rate less than 30%.

The transfer rate was calculated from a pattern height (H1) in the mold and a transferred pattern height (H2) in the microstructure according to the following equation. The pattern heights were determined with an AFM.

Transfer Rate=H2/H1×100

Continuous Transferability Evaluation

The microstructure production in each of the examples and comparative examples was continuously performed 50 times. A microstructure obtained by the first production and a microstructure obtained by the 50th production were observed on their fine patterns with an AFM. The transfer rates of the two microstructures were calculated from the fine pattern heights of the microstructures, the difference (amount of change) between the transfer rates of the two microstructures was calculated, based on which the continuous transferability was evaluated. The transfer rates were calculated according to the above-mentioned equation.

Good (good continuous transferability): The amount of change in transfer rate falls within ±20% of the initial transfer rate, where the amount of change is calculated by subtracting the transfer rate of the microstructure obtained by 50th production from the transfer rate of the microstructure obtained by first production, and where the initial transfer rate is the transfer rate of the microstructure obtained by first production; and

Poor (poor continuous transferability): The amount of change in transfer rate is out of the range of ±20% of the initial transfer rate.

TABLE 1

| | | | Example | Example | Example | Example | Example | Example |
|---|---|---|---|---|---|---|---|---|
| | | | 1 | 2 | 3 | 4 | 5 | 6 |
| Photocurable | Cationically | EHPE3150 | 20 | 20 | — | — | 10 | 100 |
| composition | polymerizable | YX8000 | 20 | 20 | — | — | — | — |
| | compound | 3,4,3′,4′- | 30 | 30 | 20 | 20 | 30 | — |
| | | Diepoxybicyclohexyl | | | | | | |
| | | CELLOXIDE 2021P | 15 | 15 | — | — | 10 | — |
| | | OXT221 | 15 | 15 | — | 20 | 50 | — |
| | | CS1140 | — | — | 70 | — | — | — |
| | | OXT121 | — | — | 10 | — | — | — |
| | | CELLOXIDE 3000 | — | — | — | 60 | — | — |
| | Radically | TMPTA | — | — | — | — | — | — |
| | polymerizable | IRR214K | — | — | — | — | — | — |
| | compound | EA1020 | — | — | — | — | — | — |
| | Initiator | HS-1PC | 6 | 6 | 6 | 6 | 6 | 6 |
| | | IRGACURE 184 | — | — | — | — | — | — |
| | Additive | MEHQ | 0.1 | — | — | — | — | — |
| | | IRG1010 | — | 1 | 1 | 1 | 1 | 1 |
| | | HP-10 | — | 1 | 1 | 1 | 1 | 1 |
| | Organic | PGMEA | — | — | 66 | — | — | 66 |
| | solvent | | | | | | | |

| | | | | | | | |
|---|---|---|---|---|---|---|---|
| Transfer | Mold | PDMS | PDMS | PDMS | PDMS | PDMS | PDMS |
| conditions | Pressure application time (sec) | 60 | 60 | 60 | 60 | 60 | 60 |
| | Applied pressure (MPa) | 0.1 | 0.1 | 0.3 | 0.1 | 0.1 | 0.3 |
| | UV irradiation intensity (mW/cm²) | 100 | 100 | 100 | 100 | 100 | 100 |
| | UV irradiation time (sec) | 60 | 60 | 60 | 60 | 60 | 60 |
| Evaluation | Mold releasability | Good | Good | Good | Good | Good | Good |
| results | Transferability | Excellent | Excellent | Excellent | Good | Excellent | Excellent |
| | Continuous transferability | Good | Good | Good | Good | Good | Good |

| | | | Example | Com. | Com. | Com. | Com. |
|---|---|---|---|---|---|---|---|
| | | | 7 | Ex. 1 | Ex. 2 | Ex. 3 | Ex. 4 |
| Photocurable | Cationically | EHPE3150 | 70 | — | — | 20 | 20 |
| composition | polymerizable | YX8000 | — | — | — | 20 | 20 |
| | compound | 3,4,3′,4′- | 20 | — | — | 30 | 30 |
| | | Diepoxybicyclohexyl | | | | | |
| | | CELLOXIDE 2021P | — | — | — | 15 | 15 |
| | | OXT221 | — | — | — | 15 | 15 |
| | | CS1140 | — | — | — | — | — |
| | | OXT121 | 10 | — | — | — | — |
| | | CELLOXIDE 3000 | — | — | — | — | — |
| | Radically | TMPTA | — | 70 | — | — | — |
| | polymerizable | IRR214K | — | — | 70 | — | — |
| | compound | EA1020 | — | 30 | 30 | — | — |
| | Initiator | HS-1PC | 6 | — | — | 6 | 6 |
| | | IRGACURE 184 | — | 5 | 5 | — | — |
| | Additive | MEHQ | — | — | — | 0.1 | 0.1 |
| | | IRG1010 | 1 | — | — | — | — |
| | | HP-10 | 1 | — | — | — | — |
| | Organic | PGMEA | 66 | — | — | — | — |
| | solvent | | | | | | |

| | | | | | | |
|---|---|---|---|---|---|---|
| Transfer | Mold | PDMS | PDMS | PDMS | Quartz | Quartz |
| conditions | Pressure application time (sec) | 60 | 60 | 60 | 60 | 60 |
| | Applied pressure (MPa) | 0.3 | 0.1 | 0.1 | 0.1 | 5 |
| | UV irradiation intensity (mW/cm²) | 100 | 100 | 100 | 100 | 100 |
| | UV irradiation time (sec) | 60 | 60 | 60 | 60 | 60 |
| Evaluation | Mold releasability | Good | Poor | Poor | Good | Good |
| results | Transferability | Excellent | Poor | Poor | Poor | Good |
| | Continuous transferability | Good | Poor | Poor | Poor | Poor |

As is demonstrated in Table 1, the methods for producing a microstructure in the examples (methods for producing a microstructure according to the present invention) provided good mold releasability and also offered good transferability and satisfactory continuous transferability. In contrast, the methods for producing a microstructure in the comparative examples did not provide mold releasability, transferability, and continuous transferability all at satisfactory levels.

The components used in the examples are as follows:

EHPE3150: 1,2-Epoxy-4-(2-oxiranyl)cyclohexene adduct of 2,2-bis(hydroxymethyl)-1-butanol (Mw: about 2000), supplied by Daicel Corporation

YX8000 (jER YX8000): Hydrogenated bisphenol-A epoxide, supplied by Mitsubishi Chemical Corporation

CELLOXIDE 2021P: 3,4-Epoxycyclohexylmethyl(3,4-epoxy)cyclohexanecarboxylate, supplied by Daicel Corporation

OXT221 (ARON OXETANE OXT221): 3-Ethyl-3{[(3-ethyloxetan-3-yl)methoxy]methyl}oxetane, supplied by Toagosei Co., Ltd.

CS1140: 1:1 (by mole) Copolymer of CYCLOMER M100 and styrene, where the copolymer has a Mw of about 40000

OXT121 (ARON OXETANE OXT121): 1,4-Bis[(3-ethyl-3-oxetanylmethoxy)methyl]benzene, supplied by Toagosei Co., Ltd.

CELLOXIDE 3000: 1,2-Epoxy-4-(2-methyloxiranyl)-1-methylcyclohexane, supplied by Daicel Corporation

TMPTA: Trimethylolpropane triacrylate

IRR214K: Tricyclodecanedimethanol diacrylate, supplied by DAICEL-CYTEC Company, Ltd.

EA1020: Bisphenol-A epoxy acrylate, supplied by Shin-Nakamura Chemical Co., Ltd.

HS-1PC: Cationic-polymerization initiator (photoacid generator), supplied by San-Apro Ltd.

IRGACURE 184: Radical polymerization initiator, supplied by BASF SE

MEHQ: Methoxyhydroquinone

IRG1010 (Irganox 1010): Antioxidant, supplied by BASF SE

HP-10 (ADK STAB HP-10): Antioxidant, supplied by ADEKA CORPORATION

PGMEA: Propylene glycol monomethyl ether acetate

### REFERENCE SIGNS LIST

1 substrate
2 photocurable transferable material layer (photocurable composition layer)
3 mold
4 light source
5 photocured layer (cured product layer)
6 microstructure (unetched)
7 microstructure (after etching)

### INDUSTRIAL APPLICABILITY

The method for producing a microstructure according to the present invention gives a microstructure that is usable in a variety of areas where microstructures obtained by nanoimprinting are used. The microstructure is extremely useful in areas such as semiconductor materials, flat screens, holograms, waveguides, media-use structures, precision machinery components, and sensors and other precision machinery components.

1. A method for producing a microstructure, the method comprising the steps of:
a) preparing a mold having a relief-patterned surface;
b) preparing a substrate;
c) forming and sandwiching a liquid photocurable transferable material layer between the substrate and the relief-patterned surface of the mold to shape the transferable material layer;
d) performing exposure of the shaped transferable material layer to convert the transferable material layer into a photocured layer; and
e) demolding the photocured layer from the mold to give the microstructure,
the step a) comprising
preparing the mold from a polymeric organic compound comprising siloxane bonds,
the step c) comprising
forming the transferable material layer from a photocurable composition comprising:
a cationically polymerizable compound (A); and
a photoacid generator (B),
the cationically polymerizable compound (A) in the photocurable composition comprising at least one compound selected from the group consisting of:
compounds represented by Formula (I); and
compounds represented by Formula (II): 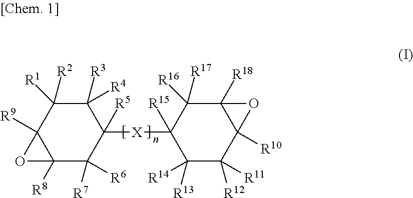
wherein n represents an integer from 0 to 10; X is, independently in each occurrence, selected from oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R¹⁸ are, identically or differently, selected from hydrogen, halogen, a hydrocarbon group optionally containing oxygen or halogen, and optionally substituted alkoxy, 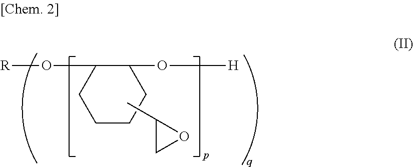
wherein R represents a group corresponding to a q-hydric alcohol, except for removing hydroxy group in a number of q from the alcohol; and p and q each represent, identically or differently, an integer of 1 or more.

2. The method for producing a microstructure according to claim 1,
wherein the cationically polymerizable compound (A) in the photocurable composition comprises at least one compound selected from the group consisting of:
epoxides excluding the compounds represented by Formula (I) and the compounds represented by Formula (II);
oxetanes; and
vinyl ethers.

3. The method for producing a microstructure according to one of claims 1 and 2,
wherein the cationically polymerizable compound (A) comprises a compound represented by Formula (III) in a content of from 0 to 80 percent by weight, Formula (III) expressed as follows: 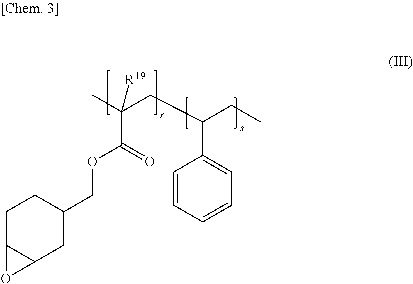
wherein R¹⁹ is, independently in each occurrence, selected from hydrogen and optionally substituted C₁-C₄ alkyl; and r and s each represent, identically or differently, an integer of 1 or more.

4. A photocurable composition for nanoimprinting to form a transferable material layer in production of a microstructure, the production comprising:
preparing a mold having a relief-patterned surface from a polymeric organic compound comprising siloxane bonds;
preparing a substrate;
forming and sandwiching a liquid photocurable transferable material layer between the substrate and the relief-patterned surface of the mold to shape the transferable material layer;
performing exposure of the shaped transferable material layer to convert the transferable material layer into a photocured layer; and
demolding the photocured layer from the mold,
the photocurable composition comprising:
a cationically polymerizable compound (A); and
a photoacid generator (B),
the cationically polymerizable compound (A) comprising at least one compound selected from the group consisting of:
compounds represented by Formula (I); and
compound represented by Formula (II): 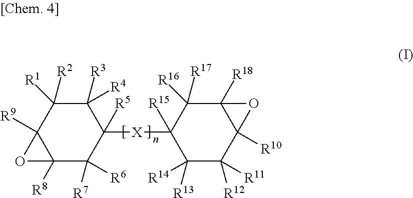
wherein n represents an integer from 0 to 10; X is, independently in each occurrence, selected from oxygen, —CH₂—, —C(CH₃)₂—, —CBr₂—, —C(CBr₃)₂—, —CF₂—, —C(CF₃)₂—, —CCl₂—, —C(CCl₃)₂—, and —CH(C₆H₅)—, where, when n is 2 or more, two or more occurrences of X may be identical or different; and R¹ to R¹⁸ are each, identically or differently, selected from hydrogen, halogen, a hydrocarbon group optionally containing oxygen or halogen, and optionally substituted alkoxy, 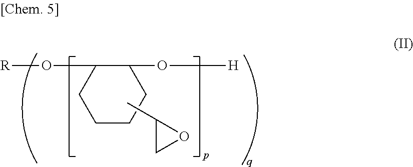
wherein R represents a group corresponding to a q-hydric alcohol, except for removing hydroxy group in a number of q from the alcohol; and p and q each represent, identically or differently, an integer of 1 or more.

5. The photocurable composition for nanoimprinting according to claim 4,
wherein the cationically polymerizable compound (A) further comprises at least one compound selected from the group consisting of:
epoxides excluding the compounds represented by Formula (I) and the compounds represented by Formula (II);
oxetanes; and
vinyl ethers.

6. The photocurable composition for nanoimprinting according to one of claims 4 and 5,
wherein the cationically polymerizable compound (A) comprises a compound represented by Formula (III) in a content of from 0 to 80 percent by weight, Formula (III) expressed as follows: 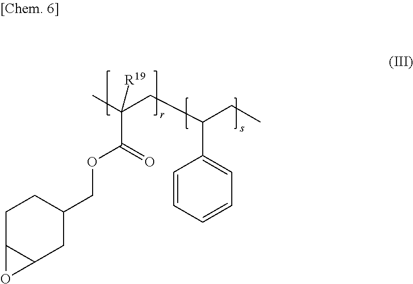
wherein R¹⁹ is, independently in each occurrence, selected from hydrogen and optionally substituted C₁-C₄ alkyl; and r and s each represent, identically or differently, an integer of 1 or more.
